(19) United States
(12) Patent Application Publication
(10) Pub. No.: US 2026/0042530 A1
(43) Pub. Date: Feb. 12, 2026

(54) RECONFIGURABLE LATTICE OF AUXETIC, BACKLASH STRUCTURES FOR SHAPE-CHANGING SYSTEMS

(71) Applicant: Northeastern University, Boston, MA (US)

(72) Inventors: Jeffrey Lipton, Sharon, MA (US); Jacob Miske, Cambridge, MA (US)

(21) Appl. No.: 19/290,987

(22) Filed: Aug. 5, 2025

Related U.S. Application Data
(60) Provisional application No. 63/679,871, filed on Aug. 6, 2024.

(51) Int. Cl. B64C 3/26; B64C 3/54

(52) U.S. Cl. CPC B64C 3/26; B64C 2003/543

(57) ABSTRACT

A reconfigurable lattice structure comprising a plurality of first unit cells arranged along a first surface region and a plurality of second unit cells arranged along a second surface region. Each unit cell has a body and multiple joint openings disposed around the body. Each second unit cell is coaxially aligned with and rotatably coupled to a corresponding first unit cell. A joint opening of a first unit cell is pivotally coupled to a joint opening of a second unit cell via a coupling element. The coupling element and joint openings collectively define a joint. The joint comprises a backlash region defined by a clearance between the coupling element and the corresponding joint openings, thereby allowing relative motion between the first unit cell and the second unit cell.

### CROSS REFERENCE TO RELATED APPLICATIONS

This application claims the benefit of priority to U.S. Provisional Patent Application No. 63/679,871, filed Aug. 6, 2024; the entire contents of which are hereby incorporated by reference.

### BACKGROUND

### Field of the Disclosed Subject Matter

The disclosed subject matter relates to reconfigurable lattice structures.

### Description of Related Art

Existing dynamic structures typically operate with fixed degrees of freedom and rely on traditional modeling approaches, such as continuum mechanics or discretized finite element analysis, to evaluate their behavior. These methods can be computationally intensive, especially when modeling complex or highly discretized geometries, limiting their practicality for real-time or adaptive applications. Conventional metamaterials, engineered to exhibit unique mechanical response through geometric restructuring, have demonstrated properties that are rarely observed in naturally occurring materials, such as negative Poisson's ratios. However, many such materials remain passive and lack the ability to adapt their behavior in response to external stimuli or operational demands.

Emerging systems, such as modular robotics and reconfigurable lattice structures, have sought to introduce active control through embedded actuators or internal energy sources. While these approaches offer greater tunability, they often face trade-offs in terms of mechanical fatigue, integration complexity, scalability, and control coordination. In particular, conventional auxetic and shape-changing structures can experience stress concentrations, limited reversibility, or degraded performance over repeated actuation cycles.

### SUMMARY

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, the disclosed subject matter includes a reconfigurable lattice structure. The reconfigurable lattice structure may comprise a plurality of first unit cells arranged along a first surface region and a plurality of second unit cells arranged along a second surface region. Each first unit cell has a body and multiple joint openings disposed around the body. The second surface region is disposed over the first surface region. Each second unit cell has a body and multiple joint openings disposed around the body. Each second unit cell is coaxially aligned with and rotatably coupled to a corresponding first unit cell. A joint opening of a first unit cell is pivotally coupled to a joint opening of a second unit cell via a coupling element. The coupling element and joint openings collectively define a joint. The joint comprises a backlash region defined by a clearance between the coupling element and the corresponding joint openings, thereby allowing relative motion between the first unit cell and the second unit cell.

The body of each of the first unit cells and the second unit cells may comprise a hub element and a plurality of arms extending radially from the central axis of the hub element. The joint openings of the first unit cell and the second unit cell may be disposed at distal ends of the respective arms. The hub element of each first unit cell and each second unit cell may comprise four arms. The coupling element may be disposed within the joint openings of adjacent arms and pivotally couple a first unit cell to a laterally adjacent second unit cell. The arms of each first unit cell and the arms of each second unit cell may be uniformly distributed about their respective central axes. Each arm of the first unit cells may have a first length and each arm of the second unit cells may have a second length, the first length equal to the second length.

The reconfigurable lattice structure may comprise an actuator operatively coupled to a first unit cell or a second unit cell. The reconfigurable lattice structure may comprise a covering layer disposed over the plurality of first unit cells such that the plurality of first unit cells is disposed between the covering layer and the plurality of second hub elements. The covering layer may comprise an elastic material. The reconfigurable lattice structure may comprise a plurality of locking mechanisms restricting reconfiguration in select regions of the lattice structure under and applied stress. At least one second unit cell may comprise a locking mechanism selectively restricting rotation of the first unit cell to which it is coaxially aligned and coupled. The locking mechanism may engage an arm of the corresponding first unit cell. The locking mechanism may comprise a latch. At least one arm of the corresponding first unit cell may have a recess configured to receive the latch. The lattice structure may transition from a planar configuration to a non-planar configuration in response to an applied load. The reconfigurable lattice structure transitioning from a first non-planar configuration to a second non-planar configuration in response to an applied mechanical force. The reconfigurable lattice structure may be compliant in a direction perpendicular to the first surface region and the second surface region. The first surface region and the second surface region may each define a surface that is one of an open surface (e.g., planar, curved) or a closed surface (e.g., cylindrical, spherical). The second unit cell, which is pivotally coupled, may be laterally adjacent to the first unit cell. The coupling element may comprise a pin.

The reconfigurable lattice structure may comprise a plurality of first hub elements, each aligned in a first plane, and a plurality of second hub elements, each aligned in a second plane, wherein the second plane is parallel to the first plane. Each of the first hub elements may have a central axis and a plurality of arms extending radially from the central axis. Each of the second hub elements may be coaxially aligned with and rotatably coupled to a corresponding first hub element. Each of the second hub elements may have a central axis and a plurality of arms extending radially from the central axis. An arm of a first hub element of the plurality of first hub elements may be pivotally coupled to an arm of a laterally second hub element of the plurality of second hub elements, thereby allowing relative motion between the first hub element and the second hub element. Each of the first hub elements and second hub elements may comprise four arms. Each arm of the first hub elements and each arm of the second hub elements may terminate in a respective joint opening. Each arm of the first hub elements may have a first length and each arm of the second hub elements may have a second length, wherein the first length is equal to the second length. The arms of each first hub element and each second hub element may be uniformly distributed about their respective central axes.

The disclosed subject matter also includes a method of configuring a reconfigurable lattice structure. The method comprises: defining a target geometry, the target geometry corresponding to a final configuration of the reconfigurable lattice structure; generating a geometric model of the reconfigurable lattice structure, the geometric model corresponding to an initial configuration of the reconfigurable lattice structure; determining local dilation factors for regions of the reconfigurable lattice structure based on the geometric difference between the geometric model and the target geometry; determining implementation parameters to match the local dilation factors; and applying the implementation parameters to the reconfigurable lattice structure, thereby reconfiguring the reconfigurable lattice structure from the initial configuration to the final configuration.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the method and system of the disclosed subject matter. Together with the description, the drawings serve to explain the principles of the disclosed subject matter.

### BRIEF DESCRIPTION OF THE DRAWINGS

A detailed description of various aspects, features, and implementations of the subject matter described herein is provided with reference to the accompanying drawings, which are briefly described below. The drawings are illustrative and are not necessarily drawn to scale, with some components and features being exaggerated for clarity. The drawings illustrate various aspects and features of the present subject matter and may illustrate one or more implementation(s) or example(s) of the present subject matter in whole or in part.

FIG. 1 is a schematic view of implementations of reconfigurable lattice structures, in accordance with the present disclosure.

FIG. 2 is a schematic view of a backlash model for an auxetic bilayer linkage within the reconfigurable lattice structure, in accordance with the present disclosure.

FIG. 3A is a perspective view of implementations of reconfigurable lattice structures configured as coverings for airfoils, in accordance with the present disclosure.

FIG. 3B is a perspective view of a covering layer disposed over a reconfigurable lattice structure, in accordance with the present disclosure.

FIG. 4 is an orthogonal top view of an implementation of rotatably coupled hub elements including a locking mechanism, in accordance with the present disclosure.

FIG. 5 is an isometric view of implementation of rotatably coupled hub elements including a locking mechanism, in accordance with the present disclosure.

FIG. 6A is an orthogonal top view of the implementation of the rotatably coupled hub elements shown in FIG. 5, in accordance with the present disclosure.

FIG. 6B is an annotated orthogonal top view of the implementation of the rotatably coupled hub elements shown in FIG. 6A, in accordance with the present disclosure.

FIGS. 7A and 7B are detailed views of an implementation of a locking mechanism, in accordance with the present disclosure.

FIGS. 8A and 8B are schematic views of implementations of a latch of a locking mechanism, in accordance with the present disclosure.

FIG. 9 is an isometric view of an implementation of a reconfigurable lattice structure including a locking mechanism, in accordance with the present disclosure.

FIG. 10 is an isometric view of another implementation of rotatably coupled hub elements including a locking mechanism, in accordance with the present disclosure.

FIG. 11 is a detailed view of an implementation of a reconfigurable lattice structure including a locking mechanism, in accordance with the present disclosure.

FIG. 12 is a graph of rotational stiffness between joints as a function of unit cell angle, in accordance with the present disclosure.

FIG. 13 is a graph of the number of degrees of freedom of revolute joints in series, in accordance with the present disclosure.

FIG. 14 is a graph illustrating the varying number of degrees of freedom of revolute joints in series, in accordance with the present disclosure.

FIG. 15 is a graph of the maximum die-off distance with varying backlash and angle, in accordance with the present disclosure.

FIG. 16 is a graph of the change in die-off distance with varying backlash and angle, in accordance with the present disclosure.

FIG. 17 is a schematic illustrating an example of a scaling reconfigurable lattice structure without backlash, in accordance with the present disclosure.

FIG. 18 is a schematic illustrating examples of dilation in reconfigurable lattice structures with backlash, in accordance with the present disclosure.

FIG. 19 is a schematic of heatmaps overlaid over the reconfigurable lattice structures shown in FIG. 18, in accordance with the present disclosure.

FIG. 20 is a schematic of three reconfigurable lattice structures with varying length and backlash showing different maximum curvatures, in accordance with the present disclosure.

FIG. 21A is a graph of maximum curvature given cell size and backlash, in accordance with the present disclosure.

FIG. 21B is a graph of die-off distance given cell size and backlash for a reconfigurable lattice structure, in accordance with the present disclosure.

FIG. 22 illustrates an implementation of a reconfigurable lattice structure shaped into an airfoil geometry through localized actuation and boundary constraints, in accordance with the present disclosure.

FIGS. 23A and 23B illustrate configurations of reconfigurable lattice structures shaped to conform to airfoil profiles through application of boundary conditions and selected dilation factors, demonstrating the ability to approximate a range of aerodynamic surface with low error, in accordance with the present disclosure.

FIG. 24 is a schematic top view of a reconfigurable lattice designed without backlash between joints, in accordance with the present disclosure.

FIGS. 25A and 25B are schematic top views of reconfigurable lattices designed with backlash between joints, in accordance with the present disclosure.

FIGS. 26A-26C are schematic top views of reconfigurable lattices illustrating variations in auxetic rotating square geometry, in accordance with the present disclosure.

FIG. 27 is a flowchart of a method for modeling and optimizing the dilation geometry across the lattice structure to achieve a global shape

### DETAILED DESCRIPTION

The various concepts introduced above and discussed in greater detail below may be implemented in any of numerous ways, as the described concepts are not limited to any particular manner of implementation. Examples of specific implementations and applications are provided primarily for illustrative purposes.

References herein to positions of elements (e.g., “top”, “bottom”) are merely used to describe the orientation of various elements in the FIGURES. It should be noted that the orientation of various elements may differ according to other exemplary implementations, and that such variations are intended to be encompassed by the present disclosure.

The disclosed subject matter is directed to a reconfigurable lattice of auxetic, backlash structures (referred to as “RLABS”) for shape-changing systems. These lattice structures can deform in response to an applied load while remaining mechanically stable in an unstressed state.

The configuration space and kinematics of a flexible lattice structure with variable degrees of freedom, useful for shape-changing robots, are provided herein. Using this framework, examples of shape-changing structures that can be constructed with a Reconfigurable Lattice of Auxetic Backlash Structures.

Implementations of the present disclosure show how a weakly linked set of auxetic mechanisms can be used to create structures with a large configuration space. This resulting structure can be used in underactuated robotics and uniquely shows a system with a variable degree of freedom. This may be modeled using a modified, realized linear unit (ReLU) algorithm and can fit a desired curvature. By connecting auxetic unit cells together with high backlash, revolute joints, a limited range of motion lattice is created with a large configuration space. Actuation of individual joints locally changes the geometry. This implementation can be used to produce variable structures, skins, molds, and foils.

Implementations of the present disclosure may be suitable for adaptive molding and manufacturing technologies. Other commercial applications may include shape-changing airfoils for modular wings. Implementations of the present disclosure represent a flexible solution for these demanding requirements.

Shape-changing structures are critical in deployable systems, manufacturing, and control surface engineering. Components engineered to modulate their surface and volume are capable of outperforming non-shape changing structures on strength-to-weight ratio, aerodynamic drag, and stowage size among other metrics. Shape-changing structures may be critical advancing dynamic system performance. For example, shape-changing structures can be used in robotics, wearable technology, and complex dynamic systems. Many of these shape-changing structures rely on deformation of sub-components to accomplish conformation to a desired shape within a configuration space.

Many shape-changing structures are composed of a unit cell repeated along a grid or lattice for stability and uniformity. A basic method to allow conformational change into a unit cell mechanism of the lattice is to introduce backlash. Backlash is a clearance or gap in a joint of a mechanism. When backlash is increased, the range of free motion for a joint increases. As the backlash of the mechanisms that comprise a structure is increased, the configuration space of the overarching structure grows. As the configuration space grows, a greater number of geometric states can be set while the structure is unstressed. For select shape-changing structures, shifts between geometric states along a configuration space can be mathematically modeled by a conformal map. A conformal map consists of a spatial variation of dilation and rotation across a body. This form of mapping preserves angles between points and the shapes of relatively small figures, but not their size or curvature. By engineering a structure to maintain a specific conformal mapping between regions of its configuration space, an unstressed, shape-changing system. If an external user is able to reconfigure the mapping function for the unit cells of the structure, the entire structure can be reconfigurable. These are the fundamental properties of an unstressed, shape-changing structure.

When most materials are placed under stress, they deform in a manner that does not follow a conformal mapping because they contract in the direction orthogonal to the applied stress. Unlike most materials, auxetic materials or structures can deform along a conformal mapping since they maintain a negative Poisson's ratio. When stressed, auxetic structures expand in the direction orthogonal to the applied stress.

A lattice structure consisting of relatively high-backlash, auxetic mechanisms can maintain a relatively large, unstressed configuration space. This system can be considered a reconfigurable lattice of auxetic, backlash structures (RLABS). RLABS maintain a variable degree of freedom due to backlash between joints and can lock into place by user input to create a system with zero degrees of freedom on demand.

As the complexity of a dynamic structure grows, the shape-changing needs of the structure may become so complex that serialized methods are insufficient. If the entire area of a control surface is modulated, the range of control offered by the dynamic structure would be increased.

These many-linked structures are capable of maintaining a wide range of structures and maintain a Jacobian solution space with many solutions across their configuration space due to the variability of the joints in series and parallel arrangements. These systems typically have a larger configuration space than serial mechanisms and it is often necessary to use a computer to calculate their forward kinematics. As the configuration space for a dynamic structure grows, the range of control in manipulating the state matrix that determines the control of the entire body increases.

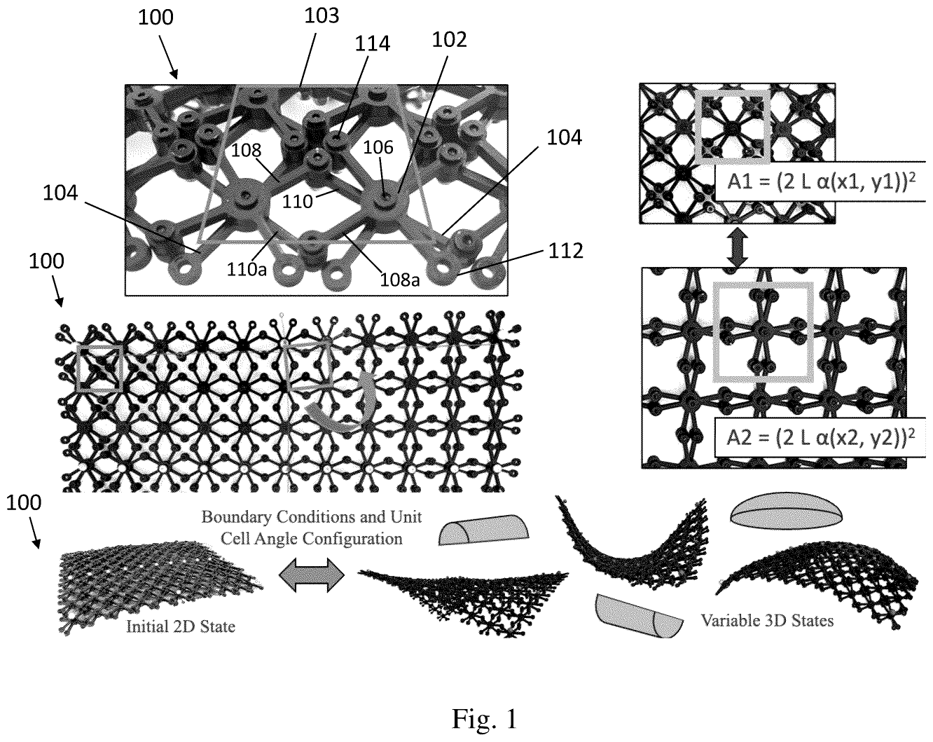

To address challenges associated with fatigue and stress in conventional auxetic structures, an electromechanically actuated, shape-changing framework was developed. The framework can be modularly composed of independent cells. FIG. 1 is a schematic view of implementations of reconfigurable lattice structures. The cellular expansion found in nature was emulated by combining servos with auxetic materials. Auxetic materials are cellular materials that expand across all perpendicular directions at the same time (i.e., materials with a negative Poisson's ratio). Each single actuator can be made up of an auxetic skeleton and an internal core that translates a servo's rotational movements into the shell's volumetric expansion.

Underactuation is a technical term used in robotics and control theory to describe mechanical systems that cannot be commanded to follow arbitrary trajectories in configuration space. This condition can occur for a number of reasons, the simplest of which is when the system has a lower number of actuators than degrees of freedom.

Prior work has shown that auxetic structures exhibit a dilation response that can be geometrically varied in space to represent a conformal map. This can allow for the generation of structures that change shape between arrangement to arrangement along a 2D configuration space as a stress is applied. This was accomplished by manufacturing an auxetic material with built-in spatial variation of cell size, limiting range of expansion when pressure is applied equally across the structure.

Prior work has shown that the conformal mapping along a configuration space can be provided by changes in the joints of an auxetic structure. By varying the stiffness in relation to deformation of joints across a structure, the range of dilation and scaling can be spatially limited. However, these methods are limited to 2D variation in structural shape across the configuration space. There is a demand for structures that can achieve many shapes after fabrication for manufacturing.

Conventional, auxetic materials are capable of conforming to variable surface areas. This is possible by using many-linked, compliant structures. This is often achieved by using a living hinge. This type of thin flexible joint (flexure) is made from the same material as the two rigid pieces it connects. In this joint, there is no mechanical backlash. Instead, deformation at the joint allows for motion of the attached, stiffer bodies. Inaccuracy in the motion and positioning of a flexure is either resultant from manufacturing defects or fatigue-induced degradation.

In mechatronics, backlash is proportional to imprecision and reducing backlash is desirable. A minimum level of backlash is unavoidable in nearly all reversing mechanical couplings, although its effects can be negated through specific methods. In many applications, the theoretical ideal would be zero back-lash, but in actual practice some backlash must be allowed to prevent jamming. Reasons for specifying a requirement for backlash include allowing for lubrication, manufacturing errors, deflection under load, and thermal expansion. A principal cause of undesired backlash is wear from a mechanism's usage. The high backlash structure in the present disclosure is able to conform to and approximate a wide range of surfaces with varying curvature.

The reconfigurable lattice structure can be implemented using auxetic tiling of a surface region. As used herein, the term “surface region” can refer to a geometric or virtual surface used to define the arrangement of unit cells in a lattice structure. The surface region can be a physical surface or non-physical surface defined in space, and can correspond to Euclidean or non-Euclidean geometries, including but not limited to planar, cylindrical, spherical, or arbitrarily curved surfaces. The arrangement of unit cells along a surface region can refer to the alignment of unit cell positions relative to the geometry of the surface region, without requiring physical attachment to a physical surface.

Auxetic tiling refers to the arrangement of unit cells across the surface, such that the lattice exhibits auxetic behavior during deformation. As used herein, a unit cell refers to a modular structural component of the reconfigurable lattice structure capable of coupling with adjacent unit cells to form a lattice network. Each unit cell includes a body, which can include a hub-and-arm configuration (e.g., as shown in FIG. 1) or a regular shape, such as a square, equilateral triangle, or regular hexagon. The unit cells can be arranged in a single layer or bilayer configuration (e.g., arranged in adjacent surface regions).

The body of the unit cell can include one or more joint openings positioned at terminal regions (e.g., ends of arms) or vertices of the body. These openings can receive coupling elements, such as pins or connectors, that form joints between unit cells and allow pivotable or rotational movement. The joints can be selectively locked to prevent movement at specific regions of the lattice structure. For example, one or more unit cells can include a locking mechanism configured to restricting reconfiguration in one or more regions of the reconfigurable lattice structure.

In some embodiments, the reconfigurable lattice structure includes a first set of unit cells (first unit cells) arranged along a first surface region and a second set of unit cells (second unit cells) arranged along a second surface region, the second surface region adjacent to or layered over the first surface region. Each unit cell can include a body having a central axis and multiple joint openings disposed at peripheral regions of the body. Each second unit cell can be positioned in registration with a corresponding first unit cell such that the body of the second unit cell is coaxially aligned with and rotatably coupled to the body of the corresponding first unit cell. A joint is formed by a coupling element received through joint openings of adjacent or neighboring unit cells, enabling relative rotational or pivotable motion between the coupled unit cells. The joint openings and/or coupling elements can be dimensioned to have an angular clearance or tolerance between the coupling element and the joint opening. This clearance introduces mechanical backlash at the join (i.e., a range of rotational motion permitted before resistance is engaged, which enables delayed or asymmetric deformation under applied forces. The amount and distribution of backlash can be varied across the lattice structure to enable programmable or spatially heterogenous mechanical responses.

In some embodiments, the lattice tiling of unit cells fully covers the surface region, forming a contiguous structure of repeated unit cells. In some embodiments, the lattice tiling of unit cells does not fully cover a surface, leaving open regions or gaps without unit cells.

As shown in FIG. 1, the reconfigurable lattice structure 100 can include multiple first hub elements 102 in a first surface region 103 (e.g., a first plane) and multiple second hub elements 104 in a second surface region (e.g., a second plane). The second surface region can be parallel to the first surface region 103. The first and second hub elements 102, 104 may be formed of a polymer, metal, or metal alloy. Each first hub element has a central axis 106 and multiple arms 108 extending radially from the central axis. Each second hub element 104 is coaxially aligned with and rotatably coupled to a corresponding first hub element. Each second hub element 104 has a central axis (colinear with a corresponding central axis of a first hub element) and multiple arms 110 extending radially from the central axis. An arm 108 of a first hub element 102 is pivotally coupled to an arm 110 of a second hub element 104, thereby allowing relative motion between the first hub elements 102 in the first surface region and the second hub elements 104 in the second surface region. The pivotable couplings between the arms of first and second hub elements define joints which can provide compliant rotational freedom. In some implementations, the pivotally coupled second hub 104 element laterally adjacent to the first hub element 102.

In some implementations, each arm 108 of the first hub elements 102 has a first length and each arm 110 of the second hub elements 104 has a second length, wherein the first length is equal to the second length. In some implementations, the first length and the second length are different. In some implementations, the arms of each first hub element 102 and each second hub element 104 are uniformly distributed about their respective central axes. In some implementations, each of the first hub elements 102 and second hub elements 104 includes four arms extending radially from a central axis. The arms may be spaced at approximately 90-degree intervals, providing a uniform distribution about the hub element's central axis.

In some implementations, each arm of the first hub elements 102 and second hub elements 104 terminate in a respective joint opening 112 configured to receive a mechanical coupling element (e.g., an arm-linking member). In some implementations, the reconfigurable lattice structure 100 includes multiple arm-linking members 114 (e.g., snap-fit joint, pin). Each arm-linking member can be received within the joint openings 112 of adjacent arms to pivotally couple a first hub element 102 to a laterally adjacent second hub element 104. For example, as shown in FIG. 1, a first arm 108a of a first hub element 102 can be pivotally coupled to a first arm 110a of a second hub element 104. The joint openings 112 can be through-holes or recessed sockets, and may include features to retain or secure the arm-linking member in place, such as press fits, detents, or retaining clips.

The reconfigurable lattice structure 100 can transition from a planar configuration (e.g., 2-dimensional state) to a non-planar configuration (3-dimensional states) in response to applied mechanical forces. Such forces can include actuator-driven deformation, boundary-induced strains, or other external loading conditions. This shape transformation occurs through the rotation and displacement of individual hub elements relative to one another, enabled by the pivotal couplings between the arms of the first and second hub elements. The resulting structure maintains compliance and can deform out-of-plane to assume a range of non-planar configurations without inducing internal stress. A cell can refer to an assembly including a coaxially aligned pair consisting of a first hub element 102 and a second hub element 104, with each hub element having multiple arms that are pivotally coupled to corresponding arms of adjacent cells. Each cell can define a local kinematic unit of the lattice and contributes to the global shape by enabling controlled dilation or contraction via angular displacement.

As shown in FIG. 1, non-planar configurations may include curved surfaces, saddle-like geometries, domed profiles, or cylindrical sections, depending on the pattern and extent of deformation induced across the lattice structure. These configurations arise from the angular relationships between interconnected cells and the compliant of the pivotable joints. The lattice structure's reconfigurability can be driven by the relative rotation of hub elements 102, 104 within each cell and the cumulative displacement across multiple cells. In some implementations, shape change is achieved without introducing significant internal stresses, owing to the backlash present in the joints and the compliant geometry of the lattice structure. This feature allows the structure to undergo large, reversible deformations and adopt various three-dimensional profiles in response to mechanical input or environmental interaction.

The reconfigurable lattice structure 100 can expand in a direction orthogonal to an in-plane tensile stress. In-plane can refer to directions that lie within or parallel to the planes defined by the first hub elements 102 and second hub elements 104. Out-of-plane can refer to directions orthogonal to both the first surface region and the second surface region. When an in-plane tensile stress is applied, the pivotally coupled arms of laterally adjacent hub elements enable the structure to undergo an auxetic response. Specifically, the angular displacement of the arms at the pivotable joints causes adjacent unit cells to rotate and reorient, leading to an increase in spacing not only along the direction of the applied tensile stress, but also in the orthogonal in-plane direction. This coordinated re-orientation results in a negative Poisson's ratio effect, allowing the lattice structure to expand both laterally and vertically expand under planar loading.

In some implementations, the reconfigurable lattice structure 100 is configured to exhibit a controlled amount of mechanical backlash between interconnected hub elements 102, 104. Backlash can refer to a non-zero angular or translational clearance between adjacent pivotally coupled arms of laterally adjacent hub elements, allowing relative movement without immediately engaging resistance.

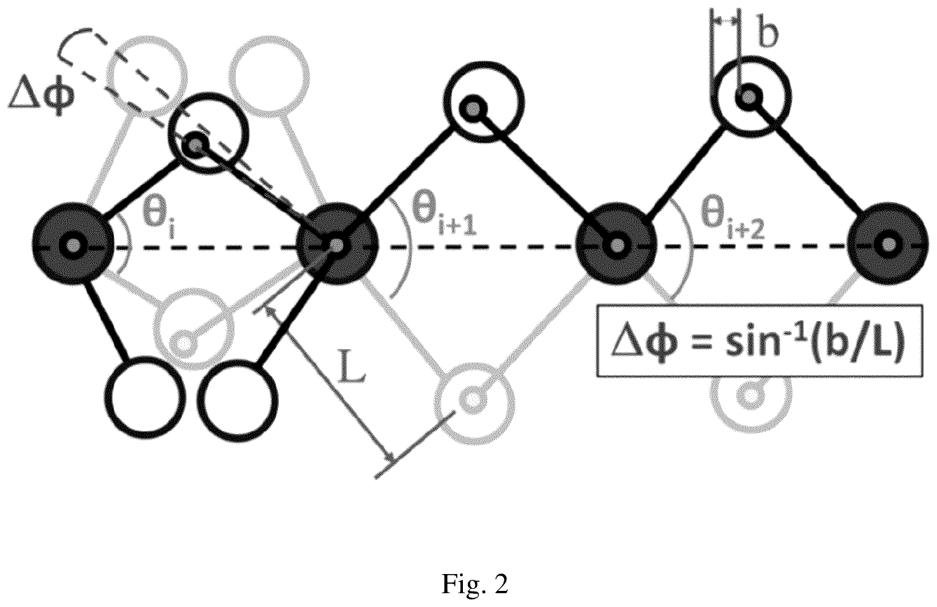

FIG. 2 is a schematic view of a simplified (1 dimensional linked) backlash model for an auxetic bilayer linkage within the reconfigurable lattice structure. FIG. 2 illustrates backlash between joints of an auxetic bilayer material resulting in a system with non-constant degrees of freedom. As a single revolute joint is rotated in the structure, there is a limited ‘die-off distance’ over which it affects other joints. A revolute joint can refer to a joint that permits relative rotational motion between two coupled component about a single fixed axis. A revolute joint can be formed by a pivotable coupling between an arm 108 of a first hub element 102 and an arm 110 of a second hub element 104. The revolute joint allows the arms to rotate with respect to one another about the axis defined by the corresponding joint opening 112.

As shown in FIG. 2, backlash may be characterized by an angular displacement of Δϕ between adjacent linkage angles (e.g., θᵢ and θᵢ₊₁), where the angular slack permits differential rotation before torque is transmitted through the structure. Backlash may be defined by a geometric clearance b between a pivot point and the opposing engagement surface, where the angular offset is related to the linkage length L according to sin⁻¹(b/l).

In various aspects, the inclusion of backlash allows the lattice to deform more gradually or to buffer abrupt changes in force transmission. In some implementations, different levels of backlash may be assigned to different regions of a reconfigurable lattice structure to produce variable local compliance.

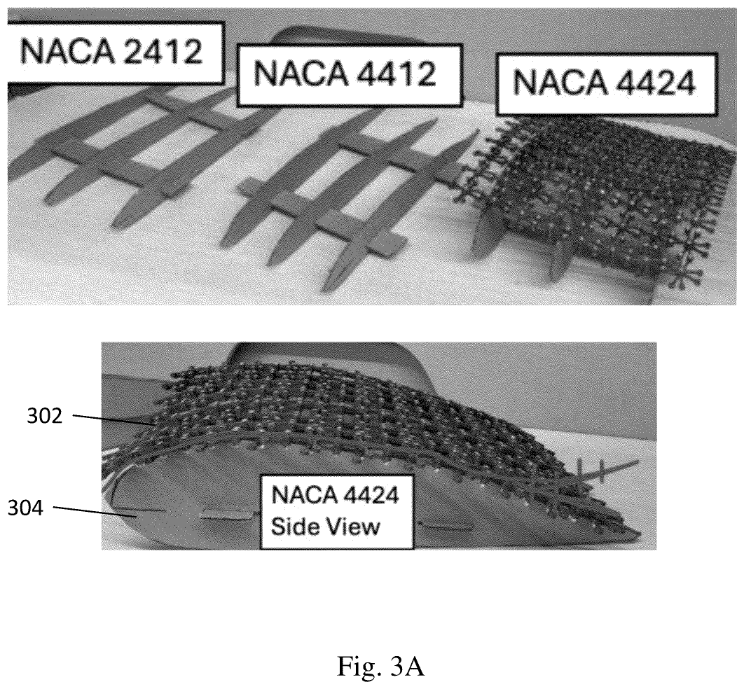

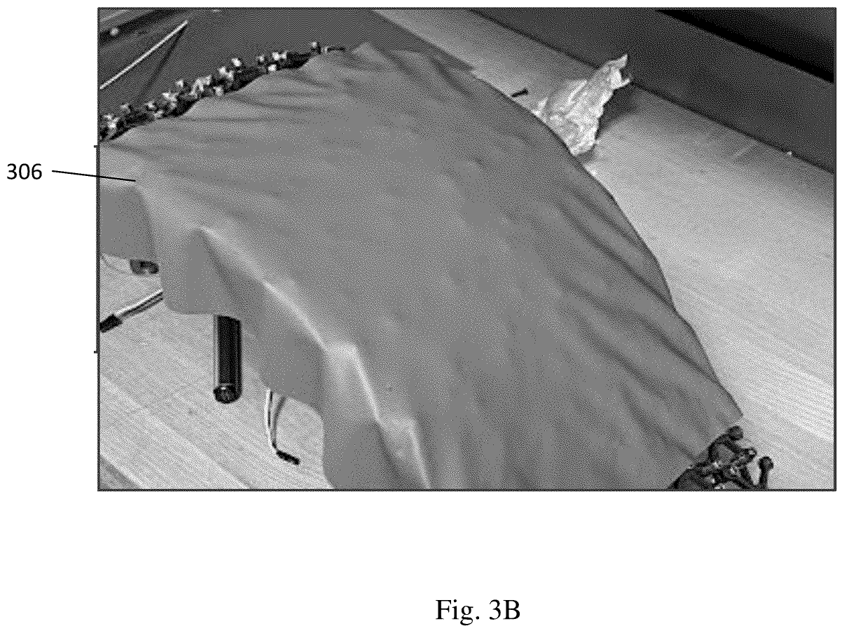

The reconfigurable lattice structure 100 can be compliant in a direction perpendicular to the first and second surface regions. In some implementations, the structure can conform to complex three-dimensional geometries, such as domes, saddles, or aerodynamic surfaces. This compliance enables the structure to accommodate a range of radii of curvature. For example, FIG. 3A illustrates a reconfigurable lattice 302 disposed over an exemplary airfoil 304. As shown in FIG. 3A, the lattice structure can adopt the curvature of the airfoil profile. The achievable curvature can be influenced by the arm length, angular resolution of the hub elements, and the mechanical properties of the joints.

In some implementations, the reconfigurable lattice structure 100 acts as a covering (e.g., skin) for an airfoil. In some implementations, the reconfigurable lattice structure 100 functions as a mechanically compliant skin that conforms to underlying geometries. For example, the lattice structure may be used as a soft robotic exterior that conforms to movement and deformation. In another example, the lattice structure may serve as a skin for aerospace components or ergonomic surface in wearable devices and automotive interiors.

In some implementations, the reconfigurable lattice structure 100 includes a covering layer disposed over at least a portion of the first hub elements such that the first hub elements are disposed between the covering layer and the second hub elements. In some implementations, the covering layer is formed of an elastic material, such as a flexible polymer, elastomeric membrane, or stretchable fabric. FIG. 3B is a schematic view of an implementation of a covering layer 306 disposed over a reconfigurable lattice structure. The covering layer can provide a continuous surface across the underlying lattice structure, smoothing over discontinuities between hub elements and arms. In some aspect, this continuous surface may be useful for application involving aerodynamic flow, user interaction, or pressure distribution. The covering layer can serve to constrain or direct local deformation, or support coordinated actuation.

In some implementations, the reconfigurable lattice structure 100 is programmable such that its geometric configuration or deformation response can be selectively defined by pre-determined inputs or constraints. In some implementations, an actuator (e.g., servo motor) is operatively coupled to one or more first hub elements 102 or second hub elements 104. The actuator can be configured to apply a force or displacement that induces a rotation of a hub element relative to its corresponding (coaxially align) hub element, or to generate angular motion between laterally adjacent hub elements. In some implementations, the actuator is directly mounted to a hub element or to an arm extending from the hub element, such that actuation produces localized rotation.

In some implementations, multiple actuators are operatively coupled to the reconfigurable lattice structure 100. The actuators may be arranged in a linear distribution (e.g., along a row or column of unit cells), in a radial or concentric pattern, or in a grid-based layout spanning multiple regions of the lattice. The actuators can operate independently, synchronously, or according to a predefined activation sequence to produce coordinated shape transformations across the structure.

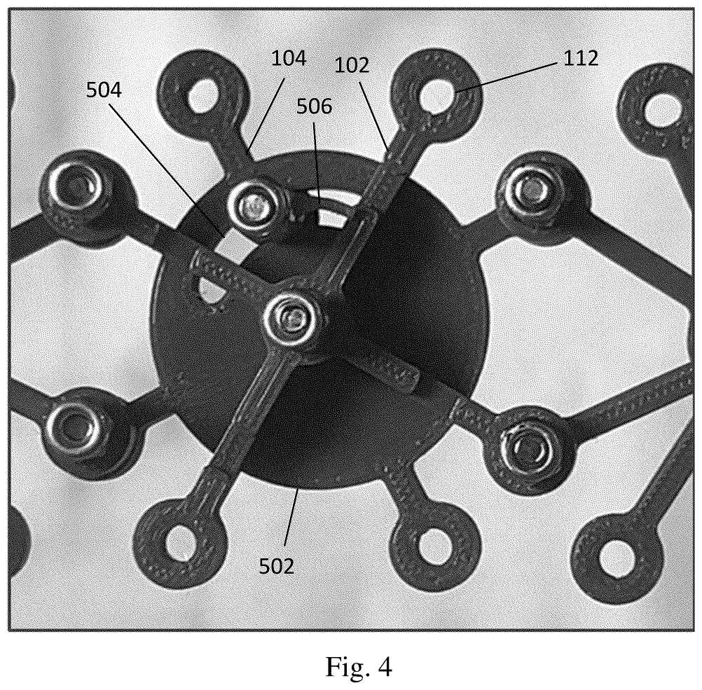

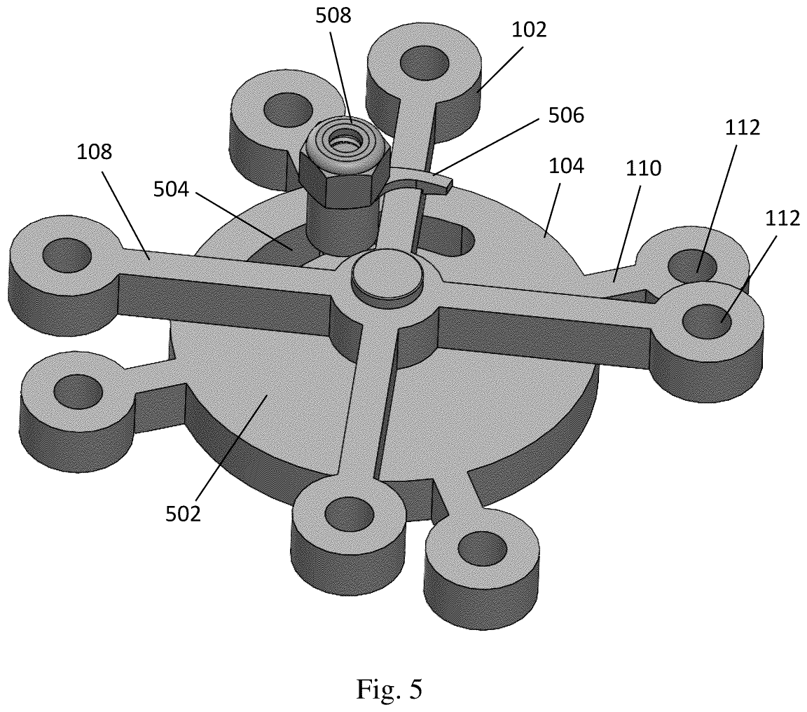

Referring to FIGS. 4-6B, views of an implementation 500 of rotatably coupled hub elements 102, 104 including a locking mechanism (e.g., hub engaging latch) are shown. In various aspects, the locking mechanism functions as a rotation limiter. In some implementations, the reconfigurable lattice structure includes at least one locking mechanism configured to restrict reconfiguration in one or more regions of the reconfigurable lattice structure under an applied stress. The locking mechanism may selectively prevent rotation between adjacent hub elements or inhibit deformation of unit cells in target portions of the structure. For example, a locking mechanism may be disposed on a second hub element 104 to engage an associated first hub element 102 to which it is coaxially aligned and rotatably coupled. The locking mechanism can engage an arm of the corresponding first hub element (the coaxially aligned first hub element). In some implementations, the locking mechanism includes a latch.

As shown in FIGS. 4-6B, the second hub element 104 can include an arcuate slot 504 formed in a region 502 of the hub (e.g., circular portion of the hub) or one of its arms. A latch 506 can extend through the slot 504 and is configured to engage a mating feature on the corresponding first hub element 102. The latch 506 can include a mechanical pin, catch, or spring-loaded plunger configured to selectively engage with an arm 108 of the first hub element 102. When the latch 506 is engaged with the first hub element 102, relative rotation between the coaxially aligned hub elements is restricted. This locking action can locally fix a unit cell and prevent actuation induced deformation at that location.

In some implementations, a mechanical fastener 508, such as a screw, nut, or threaded cap, is used to secure the latch 506 in position. The latch 506 may be fixed or slidable along the slot 504. The location of the latch 506 within the slot 504 defines the permissible range of relative motion between the first hub element 102 and the second hub element 104.

In some implementations, the arms of the first hub element 102 and the arms of the second hub element 104 differ in geometry or functional features. In some aspects, hub elements with differentiated arm features can support modular tuning of the lattice structure's mechanical response. In some implementations, the arms of the first hub element 102 are longer than the arms of the second hub element 104. In some implementations, an arm of the first hub element 102 can include an engagement feature configured to engage with the locking mechanism (e.g., latch 506). In some implementations, each of the arms of the first hub element 102 includes an engagement feature.

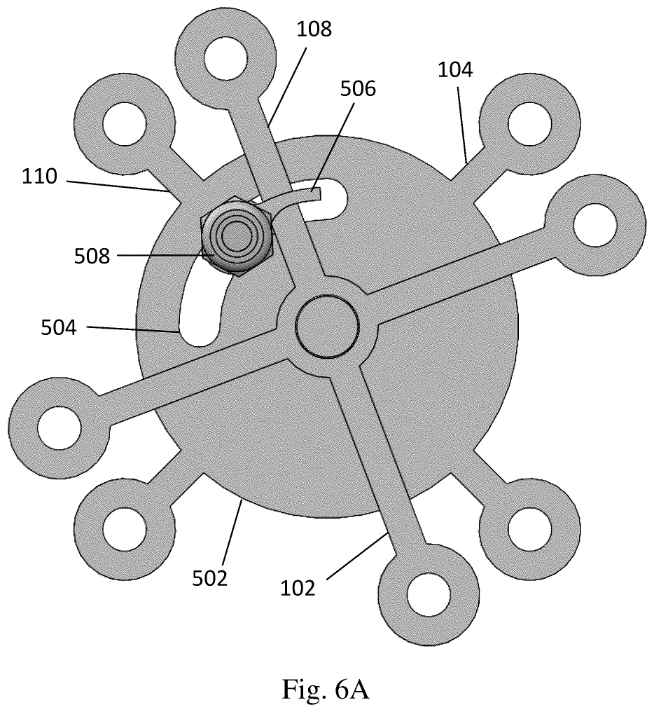

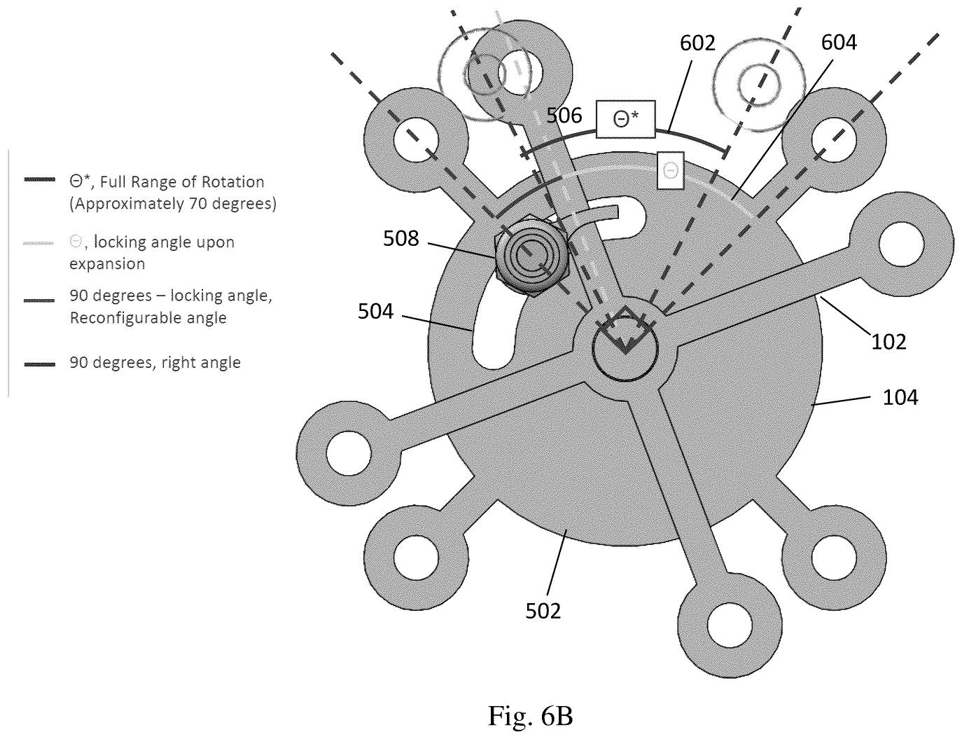

FIG. 6B is an annotated orthogonal top view of the implementation of the rotatably coupled hub elements shown in FIG. 6A. As shown in FIG. 6B, the locking mechanism defines the angular limits of rotation, thereby constraining relative movement to a locking angle. In some implementations, the total free rotation range 602 may be approximately 70 degrees.

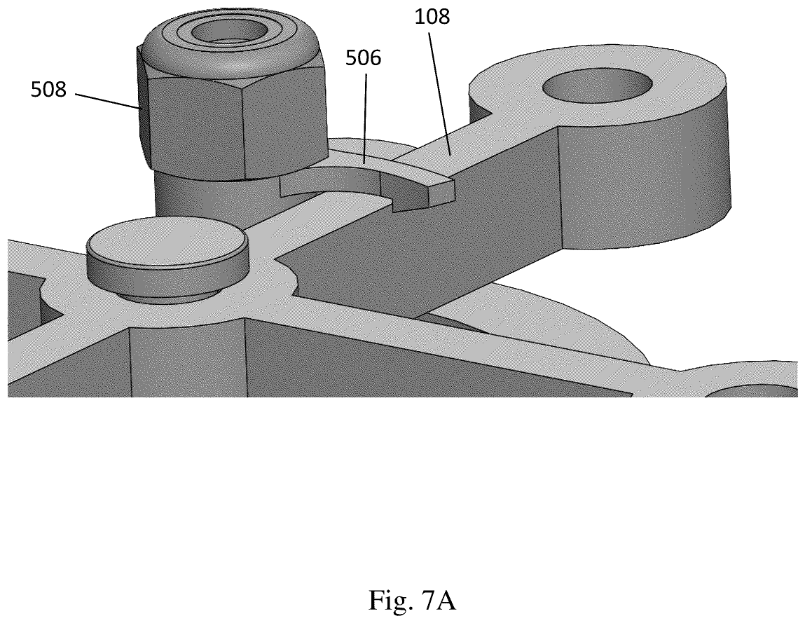

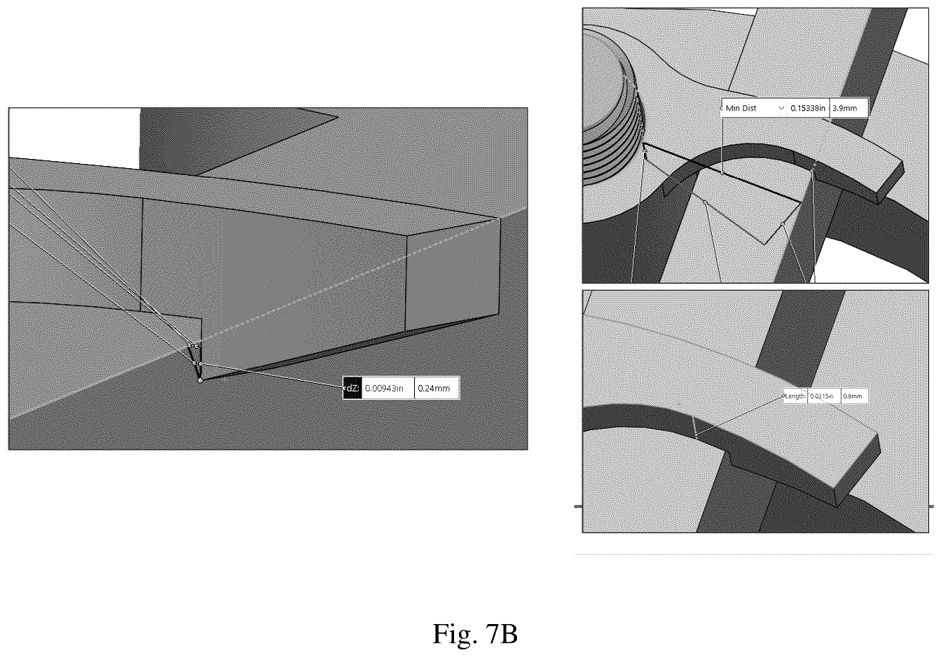

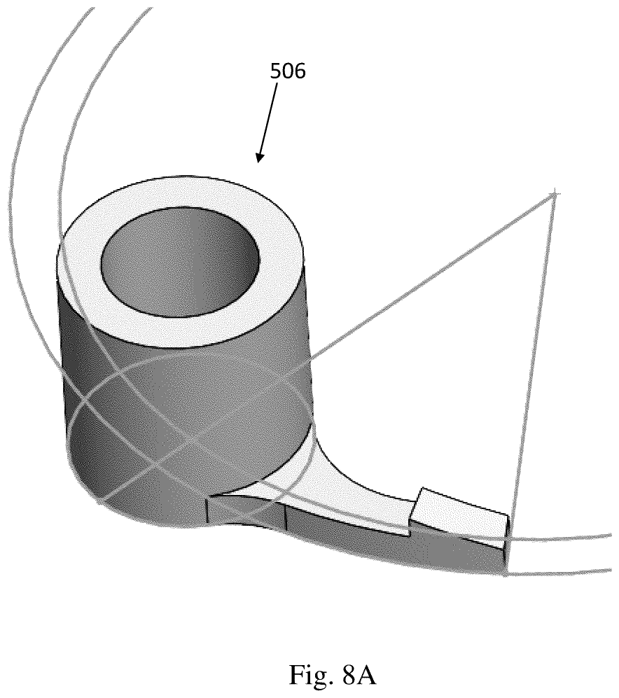

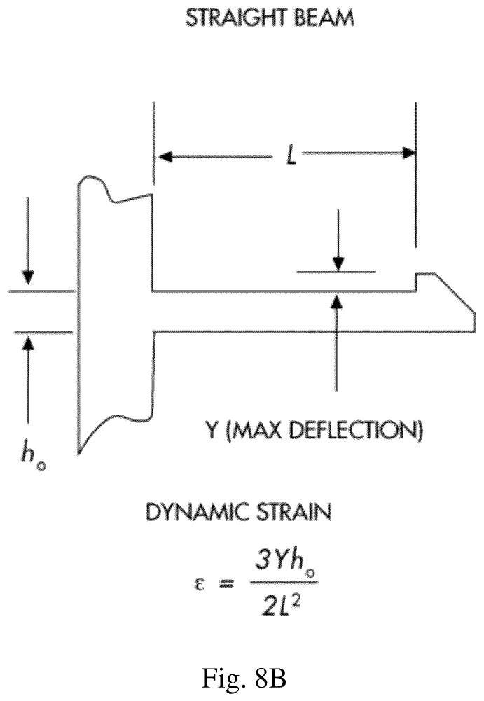

FIGS. 7A-7B are detailed views of an implementation of a locking mechanism. FIGS. 8A and 8B are schematic views of the latch 506 configured to serve as a compliant locking mechanism. The latch 506 can include a straight beam geometry with a fixed base end and a free end that deflects under applied loads. The latch 506 can elastically deform to engage and disengage from an engagement feature of the first hub element 104 (e.g., notch, groove, recess). In some implementations, the latch 506 is integral with the first or second hub element. The latch 506 can be tuned to a specific locking force or engagement threshold by adjusting its geometry and material stiffness. The latch 506 may be formed of a polymer, metal, or metal alloy.

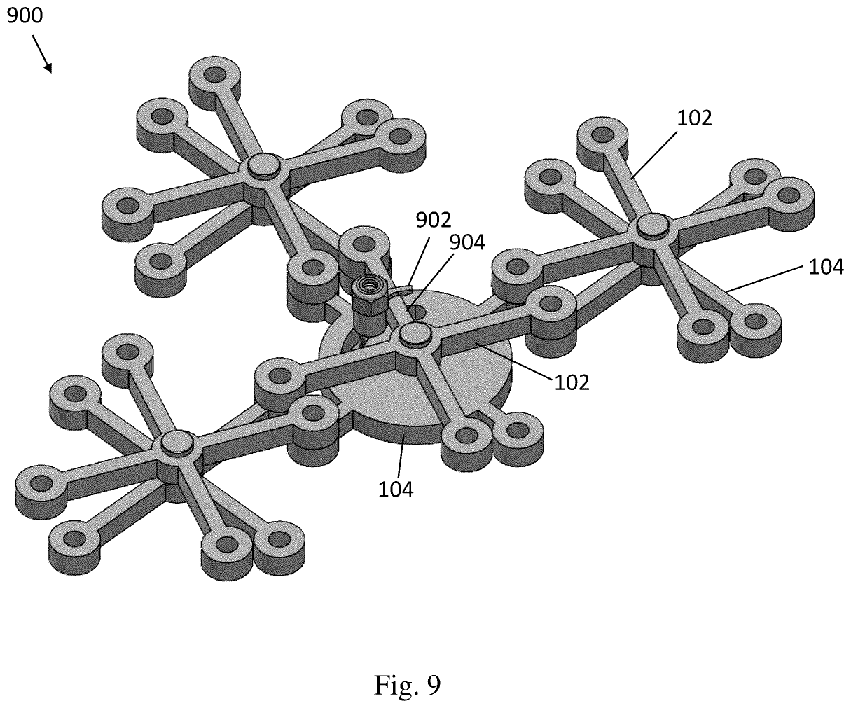

FIG. 9 illustrates a portion of reconfigurable lattice structure 900 with multiple hub elements arranged in two parallel planes: first hub elements 102 in a first plane and second hub elements 104 in a second surface region. Each hub element includes multiple radially extending arms, with each arm terminating in a joint opening. Adjacent arms from neighboring hub elements are pivotally coupled via arm-linking members, such as pins, allowing for relative angular displacement between the hub elements in the lattice structure.

FIG. 9 illustrates the coaxial alignment of each second hub element 104 with a corresponding first hub element 102, forming stacked pairs that rotate relative to one another about a shared central axis. A locking mechanism 902 is integrated into one of the second hub elements. The locking mechanism 902 can include a latch that engages with an engagement feature 904 of the underlying first hub element. The engagement feature 904 can include a recess (e.g., recess 1002) formed in the arm of the first hub element or the exterior surface of the arm.

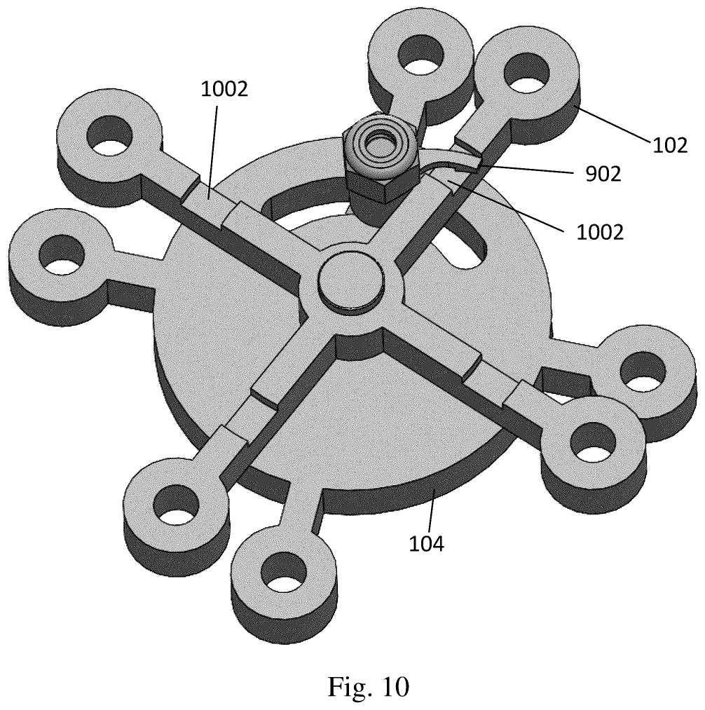

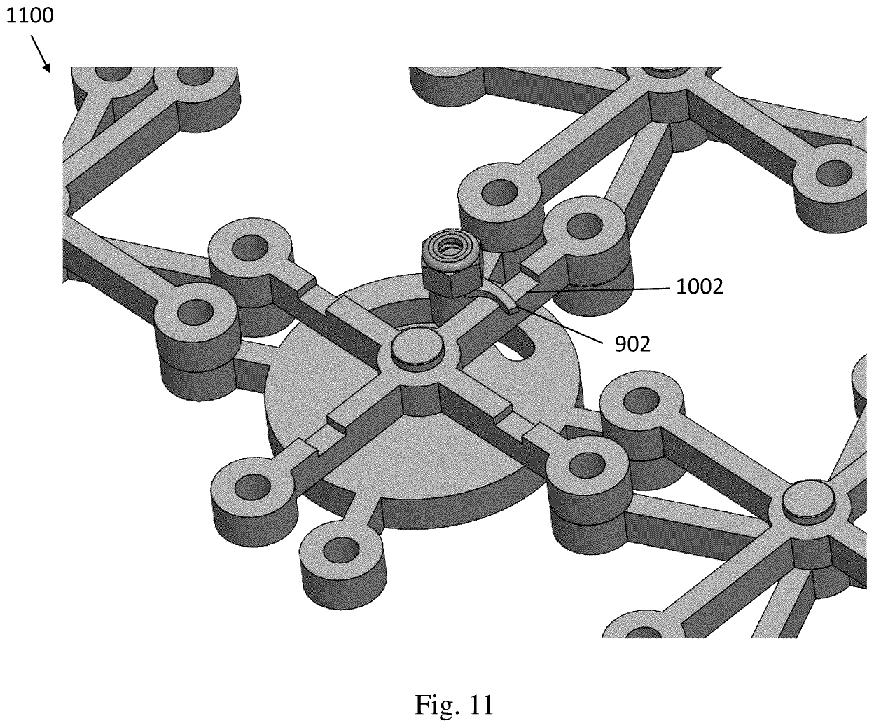

FIG. 10 illustrates an implementation of rotatably coupled hub elements 102, 104 including a locking mechanism (e.g., hub engaging latch), wherein the first hub element 102 includes multiple recesses 1002. In some implementations, at least one arm of the first hub element 102 includes a recess 1002 configured to receive locking mechanism 902 (e.g., latch). The recess 1002 can be uniformly positioned, such that each is located at the same radial distance from the central axis of the corresponding hub element. FIG. 11 is a detailed view of an implementation of a reconfigurable lattice structure 1100 including a locking mechanism 902 that engages with an underlying recess 1002.

In some implementations, the reconfigurable lattice exhibits a die-off distance extending outward from a hub element (e.g., an actuated hub element). The die-off distance may correspond to a number of adjacent unit cells over which the mechanical influence of an applied actuation force is distributed. Within this region, the angular displacement of arms and corresponding deformation of the structure gradually attenuate with increased distance from the actuated location. The extent of the die-off distance can depend on various factors, including mechanical stiffness of the arms, compliance of the joints, the magnitude of the applied actuation force, the locking state of nearby hub elements, and surrounding boundary conditions. In some implementations, the die-off distance may encompass two to six unit cells from the actuation point, beyond which the lattice structure remains substantially unaltered.

In some implementations, the reconfigurable lattice structure includes a control system configured to assign a dilation factor to one or more unit cells of the lattice structure. The dilation factor corresponds to a target local deformation and defines the extent to which a unit cell is expanded of contract, A dilation function may be applied to generate a spatial distribution of dilation factors across the lattice. In various aspects, this spatial variation allows the structure to deform in a programmable and predictable manner, enabling the lattice to conform to target non-planar geometries. In some implementations, the assigned dilation factors are physically realized through actuator inputs, which control the angular orientation or displacement of hub elements to produce local expansion. The dilation factors may be implemented via boundary constraints or pre-defined mechanical limits embedded in the lattice structure.

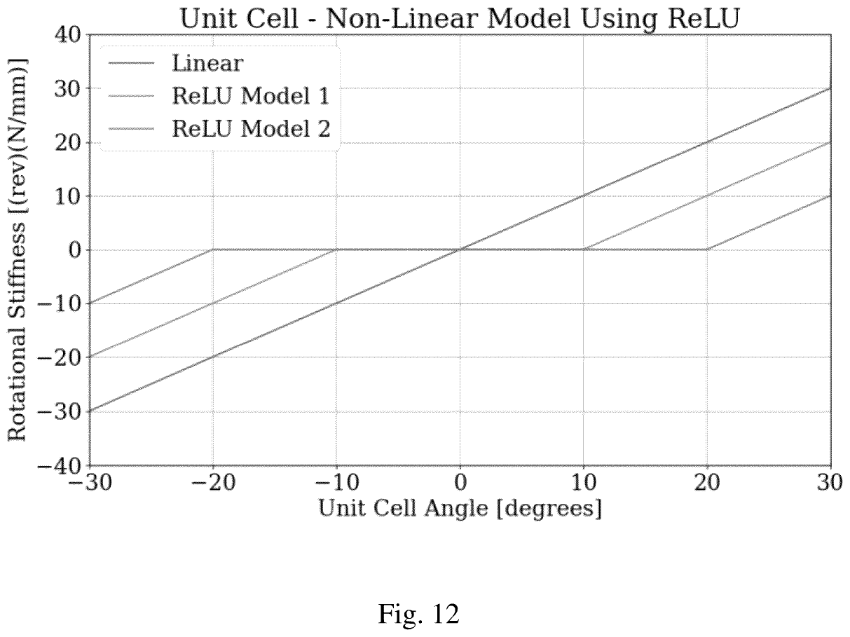

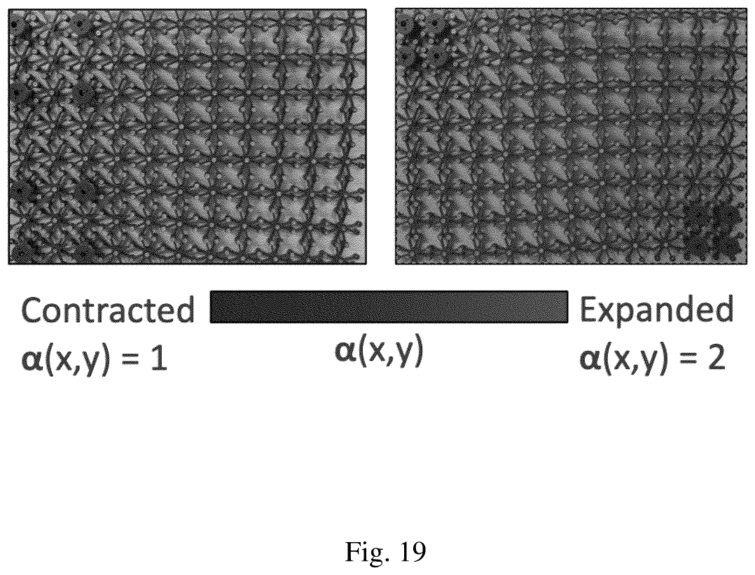

FIGS. 12-21B illustrate the mechanical behavior, control parameters, and

performance characteristics of reconfigurable lattice structures composed of a series of interconnected unit cells with revolute joints. FIG. 12 shows the rotational stiffness of an individual unit cell as a function of the cell angle. Both linear and non-linear models using rectified linear units are shown. The non-linear model captures asymmetric stiffness behaviors under positive and negative angular deformation.

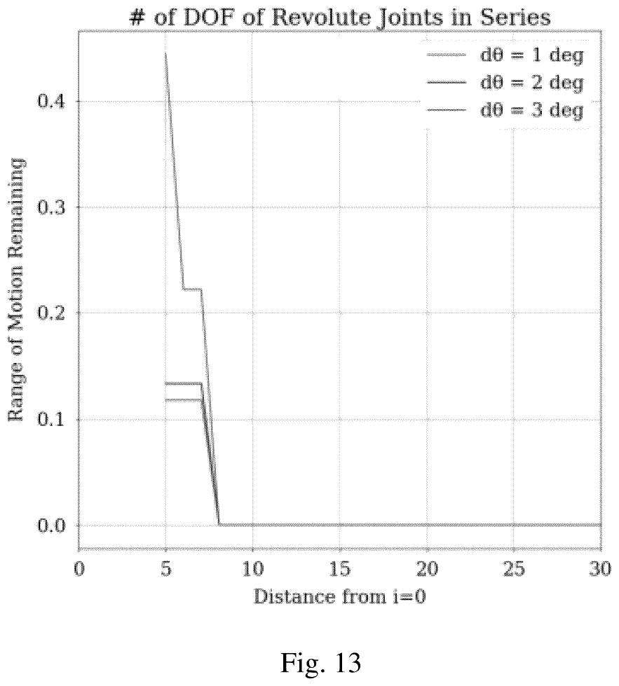

FIG. 13 presents the range of motion remaining along a chain of revolute joints as a function of distance from a driven cell (i=0) for various angular inputs. The figure illustrates that for higher initial displacements, the range of motion dies off more rapidly.

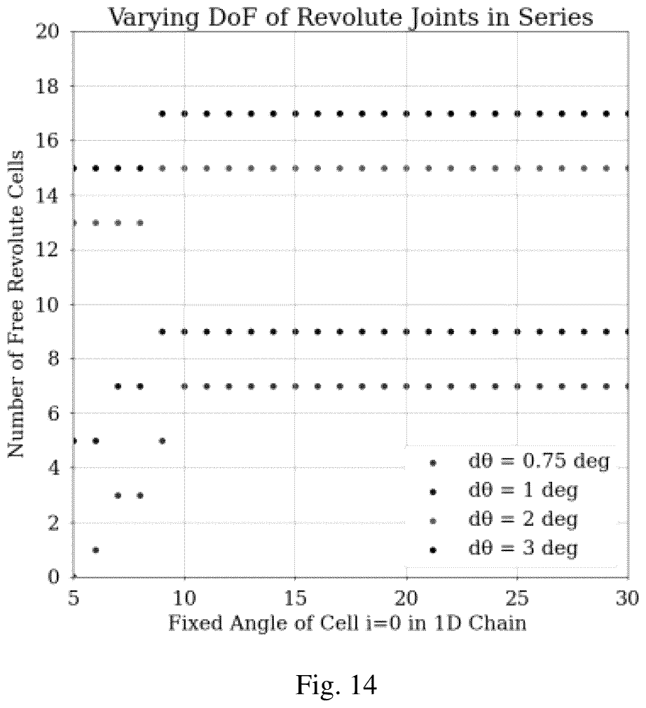

FIG. 14 shows the number of free revolute joints in a 1D chain, varying as a function of fixed angle at the driven cell (i=0) and the angular inputs applied to adjacent joints. The distribution of free cells illustrates how greater angular displacements reduce the number of joints that can response before reaching mechanical limits.

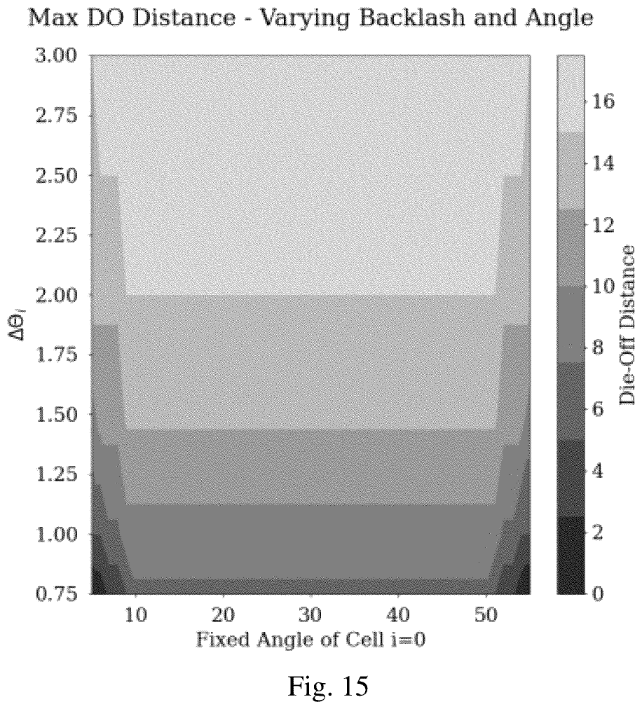

FIG. 15 illustrates a heat map of the maximum die-off distance as a function of backlash and initial drive angle. The figure illustrates how increasing backlash reduces the maximum controllable range in the structure.

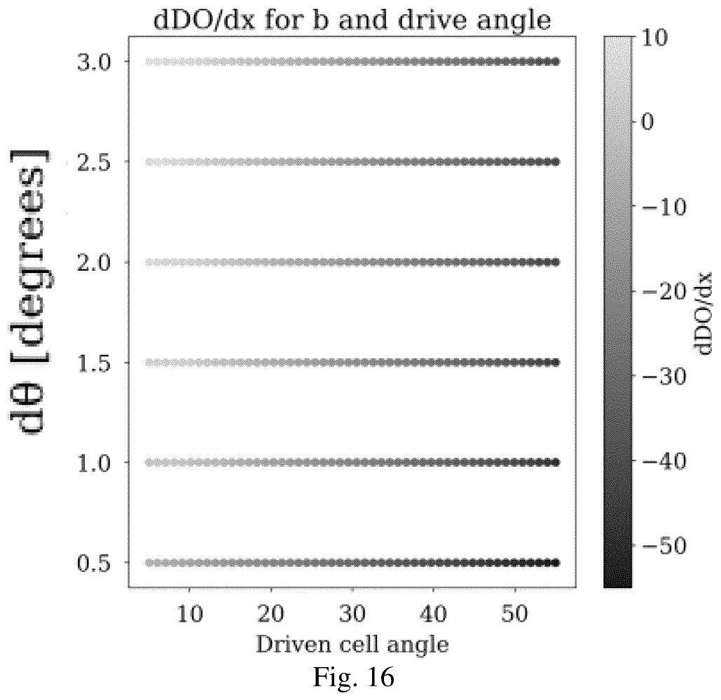

FIG. 16 shows the spatial gradient of the die-off distance with respect to the driven cell angle and backlash value. The plot illustrates how changes in input parameters affect the rate at which motion decays spatially.

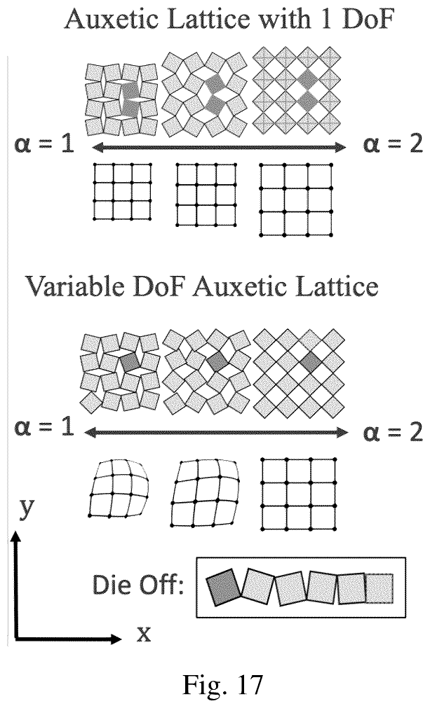

FIG. 17 is a schematic comparing lattice structures with constant and spatially varying dilation factors. As shown in the top row, a uniform dilation factor across the lattice structure produces homogenous deformation. In contrast, spatially varying the dilation factor (bottom row) yields spatially graded deformations and curvatures. The die-off behavior is also illustrated as deformation diminishes away from the driven edge.

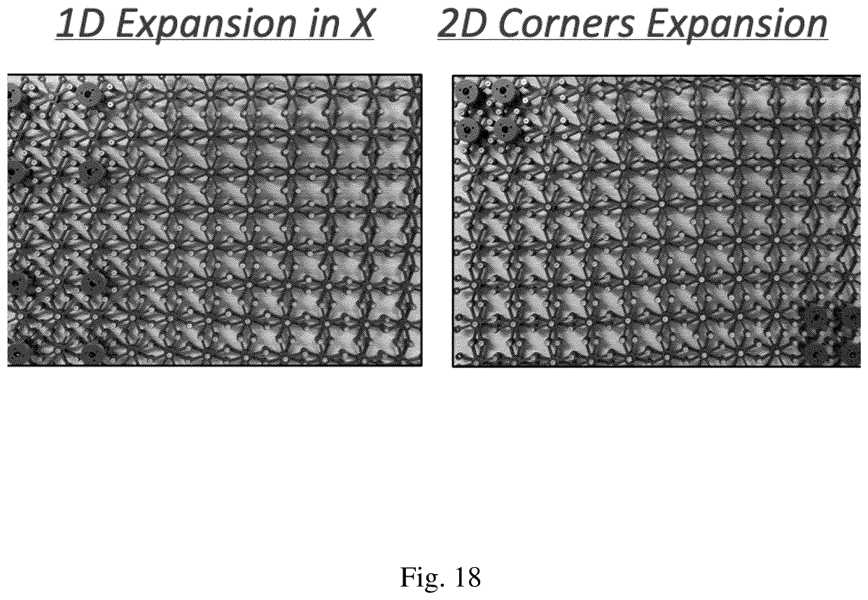

FIG. 18 illustrates lattice structures undergoing expansion in one dimension (left) and expansion from corner points (right), illustrating that dilation directionality can be governed by boundary actuation points.

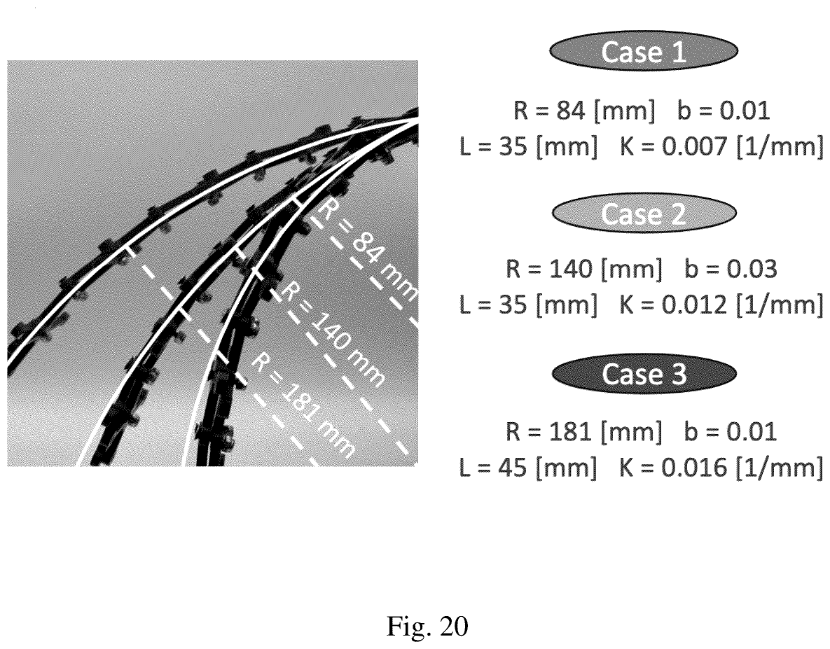

FIG. 20 a schematic of three reconfigurable lattice structures with different maximum curvatures (R=84 mm, 140 mm, 181 mm) by adjusting cell length and offset b. The parameter K, representing curvature, is shown to scale with geometry.

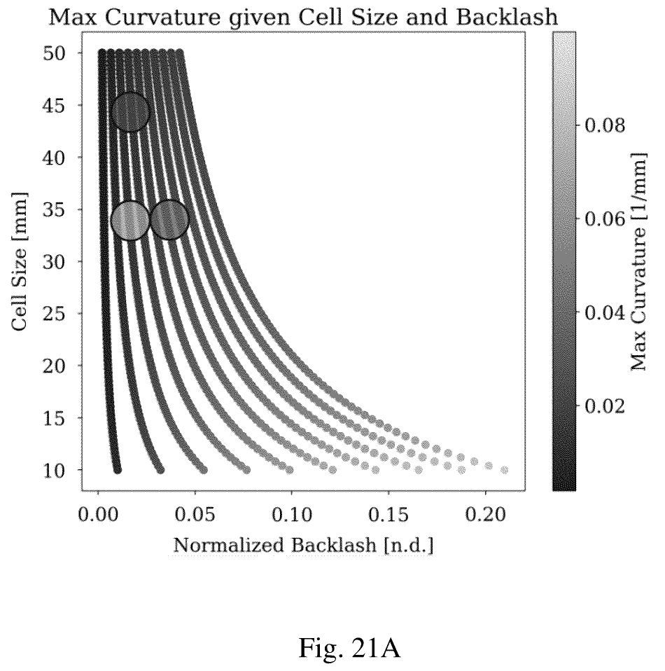

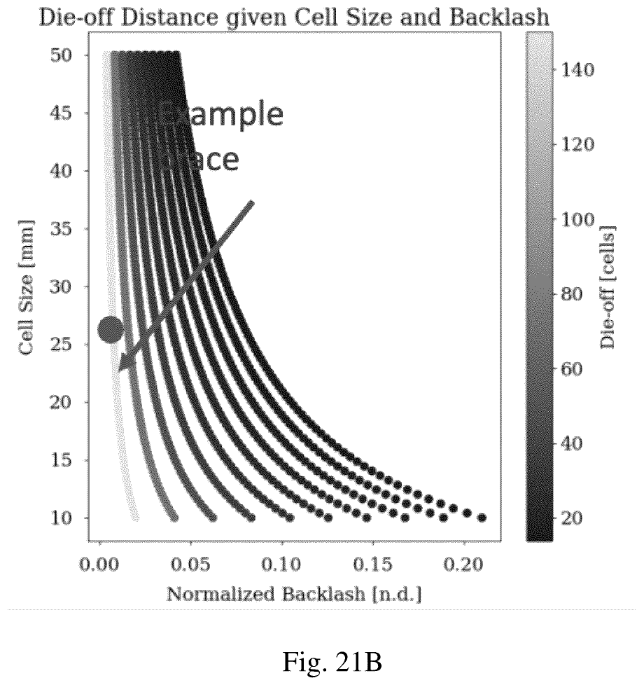

FIGS. 21A and 21B illustrates how the cell size and backlash influence the maximum achievable curvature and die-off distance, respectively. As shown, larger backlash reduces the curvature and shortens the die-off distance, whereas smaller backlash allows greater control fidelity over longer regions. Curvature in the lattice structure may be generated purely through geometric parameters such as cell size and backlash, without inducing internal stresses.

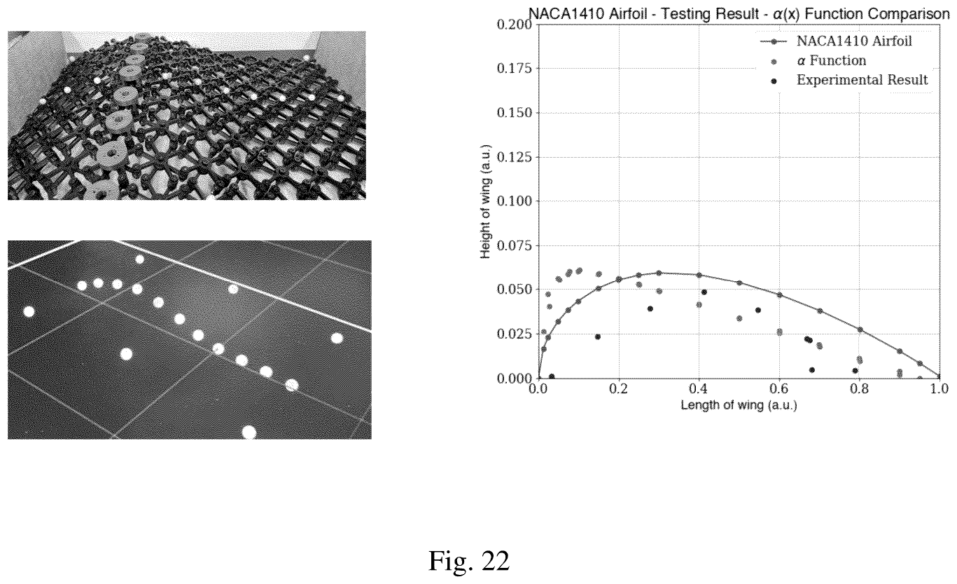

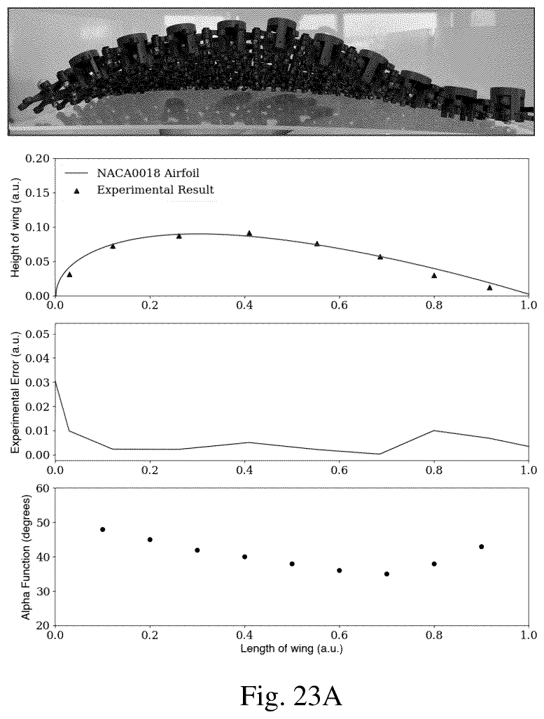

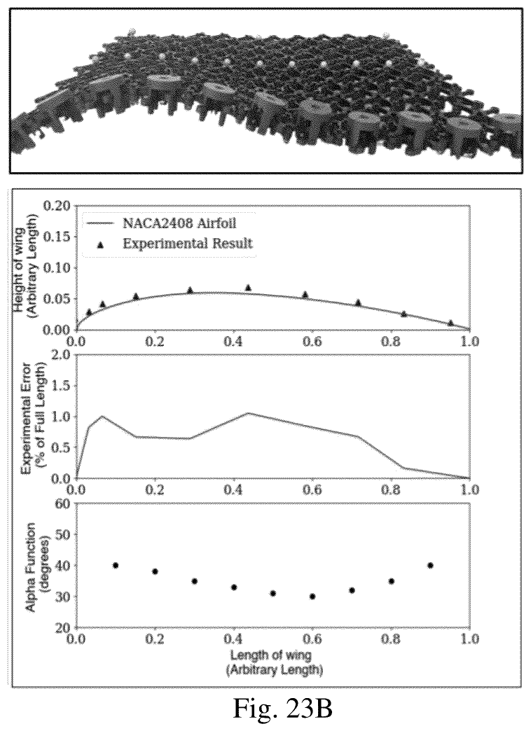

FIGS. 22-23B illustrate experimental validations of reconfigurable lattice structures configured to approximate airfoil geometries using spatially varying dilation factors. FIG. 22 shows an example of a physical lattice with markers for motion tracking. The plot in FIG. 22 illustrates a comparison of the height profile of a deformed lattice configured to emulate an airfoil, the target dilation function (a), and the experimental marker data. The plot indicates that the system is capable of replicating the desired curvature profile. FIG. 23A and FIG. 23B further demonstrate the ability of reconfigurable lattice structures to approximate airfoil profiles.

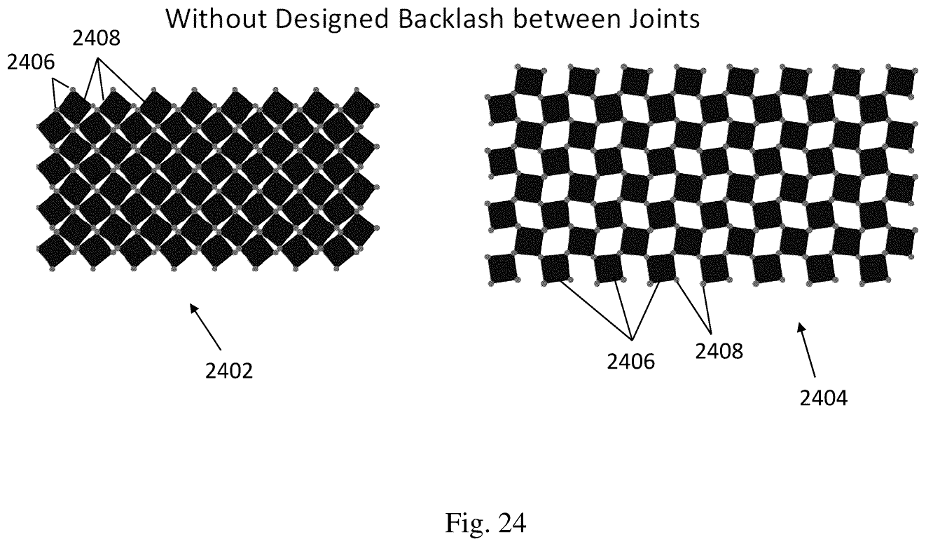

Referring to FIG. 24, a reconfigurable lattice structure is shown in a compact configuration 2402 and in an expanded configuration 2404. The reconfigurable lattice structure includes multiple cells 2406 interconnected at joints 2408 that are designed without backlash between joints. As such, the transformation from the compact configuration 2402 to the expanded configuration 2404 reflects a uniform change in spacing between adjacent unit cells 2406. This results in symmetric variation across the lattice, without introducing spatial variation in dilation factor or angular displacement at individual joints.

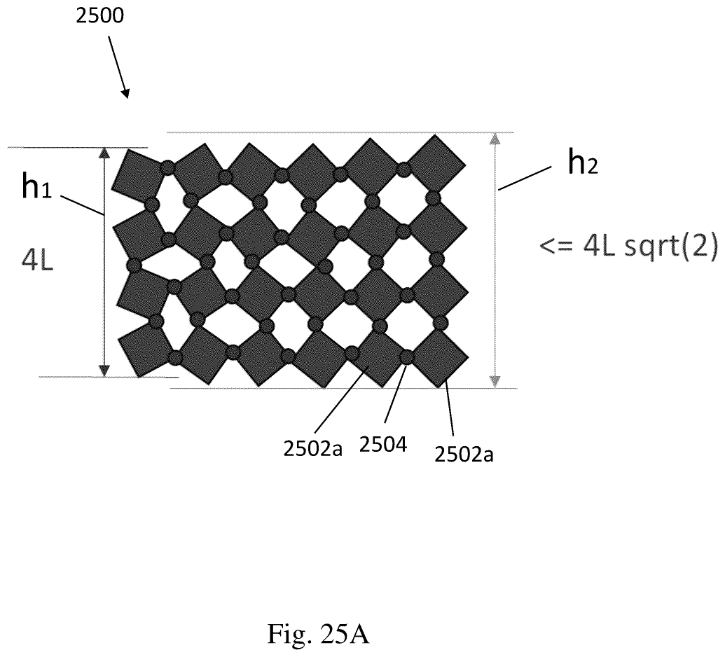

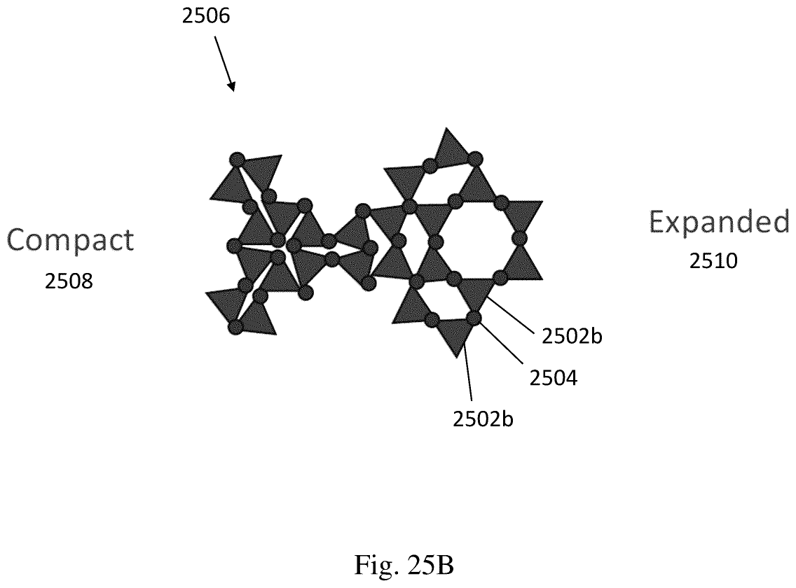

Referring now to FIGS. 25A and 25B, top-down views of RLABS geometrics (i.e., geometries of reconfigurable lattice structures designed with backlash between the joints) are shown. As shown in FIGS. 25A and 25B, the reconfigurable lattice structures exhibit programmable dilation and auxetic behavior through variation in unit cell geometry and joint configuration. In FIG. 25A, the structure 2500 includes square-shaped unit cells 2502a connected by joints 2504. The unit cells 2502a are arranged in a repeating pattern such that each square is connected at its corners to adjacent squares. Notably, the structure 2500 can exhibit a variation in vertical extent between the left and right bounding edges: the left side of the structure spans a first height h₁, while the right side spans a second height h₂ different from the first height. This asymmetric profile results from the differing rotational orientations across the lattice, specifically, the unit cells 2502a near the right edge are rotated further relative to those proximate the left side of the lattice structure, thereby increasing the vertical projection of the structure on that side. The overall geometry of the lattice can be altered through the relative rotations at the joints 2504, without changing the size or shape of the unit cells. In FIG. 25B, the reconfigurable lattice structure 2506 includes triangular unit cells 2502b interconnected via joints 2504. As shown in FIG. 25B, the lattice structure can include one or more compact regions 2508 and one or more expanded regions 2510. The inter-cell spacing in the compact regions 2508 can be smaller than the inter-cell spacing in the expanded regions 2510 of the lattice structure. The angular displacement in the compact regions 2508 between neighboring unit cells can also be smaller than that in the expanded regions 2510. In this way, the backlash designed into the joints 2504 allows for directional and spatially heterogeneous dilation of the structure.

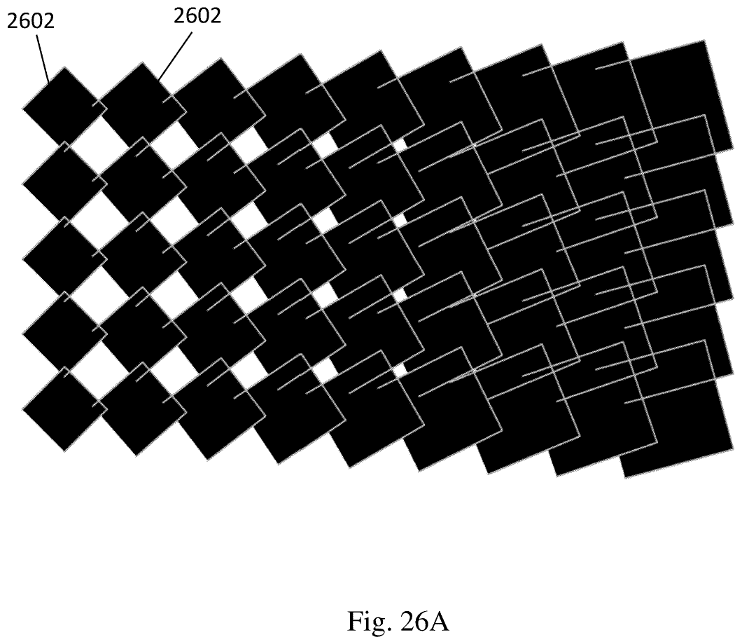

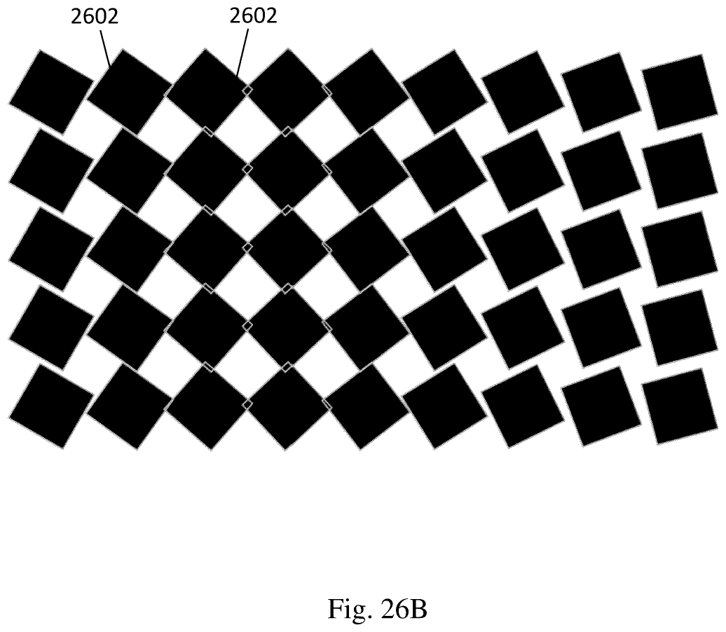

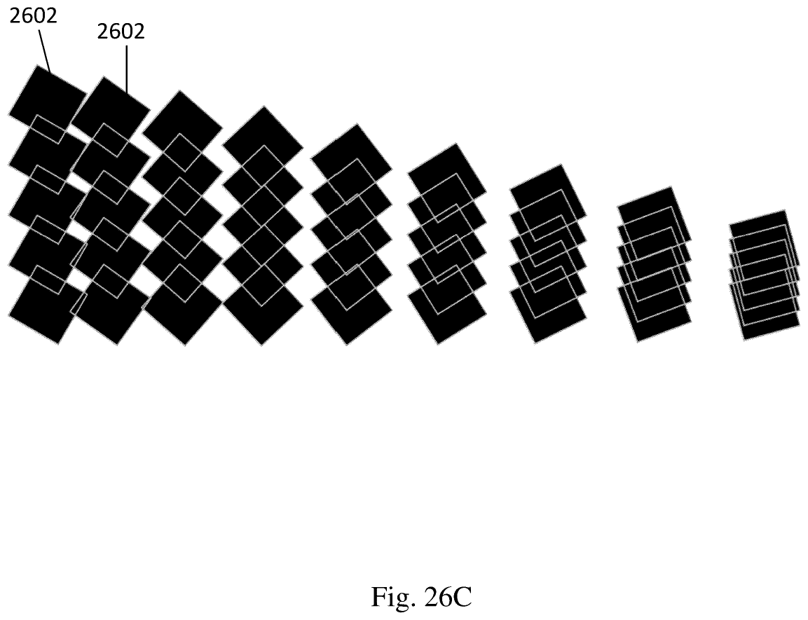

FIGS. 26A-26C are schematic top views of reconfigurable lattice structures illustrating variation in auxetic rotation square geometry across a linkage array. FIG. 26A shows variation by size of the unit cells 2602. In some embodiments, the unit cells are configured to vary in body size across the lattice. FIG. 26B shows variation by angular displacement of adjacent unit cells. In some embodiments, the angular displacement between adjacent unit cells is varied. FIG. 26C shows variation by height. In some embodiments, the height of different regions of the lattice structure is varied.

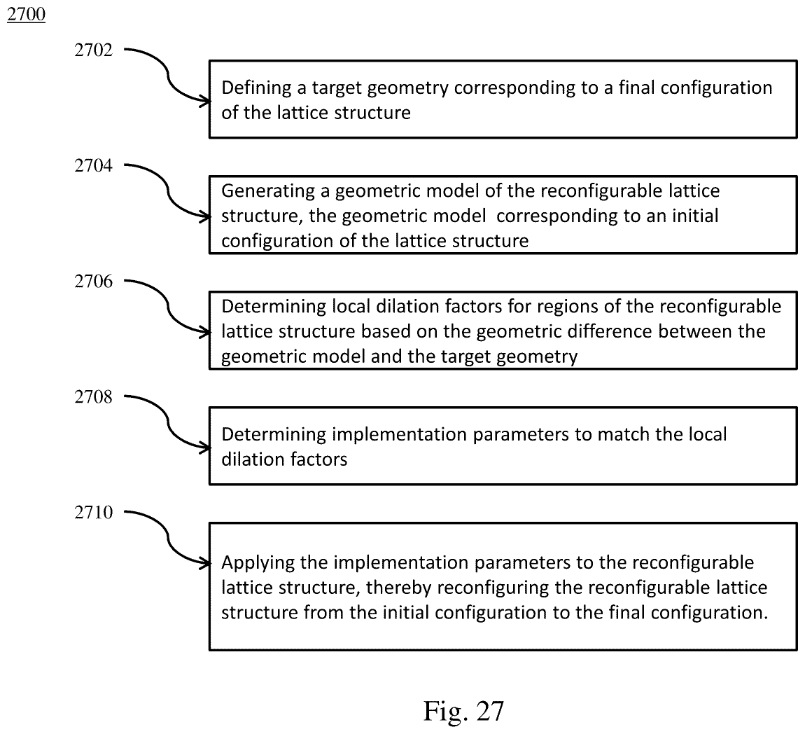

Referring to FIG. 27, the present disclosure also provides a method 2700 of modeling and optimizing the dilation geometry across the lattice structure to achieve a global shape. In some embodiments, the reconfigurable lattice structure is configured based on a programmable modeling framework that enables predictive deformation of the lattice structure. This framework can allow for the design of complex shape transformations by systematically controlling dilation, joint behavior, and actuator inputs across a network of unit cells.

At 2702, a target geometry corresponding to the desired final configuration of the lattice structure can be defined. The target geometry may correspond to a 2D configuration (planar) or a 3D configuration (e.g., cylindrical, spherical, curved). At 2704, a geometric model of a reconfigurable lattice structure can be generated, defining an initial configuration of the lattice structure. The model can define unit cell positions, connectivity between unit cells, joint behavior, and actuator response characteristics. The model can be used to simulate deformation behavior under different dilation conditions. At 2706, local dilation factors for regions of the lattice structure can be determined based on the geometric difference between the initial configuration and the target geometry. These dilation factors can define the relative expansion or contraction in different regions (e.g., between adjacent cells) of the lattice structure. These dilation factors can define the local change in spacing between unit cells. At 2708, implementation parameters are determined to produce the local dilation factors across the lattice structure. In some implementations, step 2708 can include determining angular displacements between unit cells. The angular displacements can be used to calculate the rotation angle of actuators and determine joint states (e.g., locked or unlocked joints) required to achieve the target geometry. The implementation parameters can include actuator positions and motions (e.g., angles of rotation), structural configurations (e.g., locked or unlocked joint states), and spatial distribution of deformation inputs (e.g., locations of actuators). In some embodiments, the implementation parameters are used to selectively actuate, constrain, or permit motion at specific joints to induce the modeled deformation. At 2710, the implementation parameters are applied to the reconfigurable lattice structure, thereby reconfiguring the lattice structure from the initial configuration to the final (target) confirmation. Actuators can be controlled to produce localized or distributed deformation.

The disclosed system may be embodied in other specific forms without departing from the spirit or essential characteristics thereof. The foregoing implementations are therefore to be considered in all respects illustrative, rather than limiting of the invention. Having thus described several illustrative implementations, it is to be appreciated that various alterations, modifications, and improvements will readily occur to those skilled in the art. Such alterations, modifications, and improvements are intended to form a part of this disclosure, and they are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one implementation are not intended to be excluded from similar or other roles in other implementations. Additionally, elements and components described herein may be further divided into additional components or joined together to form fewer components for performing the same functions. Accordingly, the foregoing description and attached drawings are by way of example only, and they are not intended to be limiting.

1. A reconfigurable lattice structure, comprising:
a plurality of first unit cells arranged along a first surface region, each first unit cell having a body and multiple joint openings disposed around the body;
a plurality of second unit cells arranged along a second surface region, the second surface region disposed over the first surface region, each second unit cell having a body and multiple joint openings disposed around the body, each second unit cell coaxially aligned with and rotatably coupled to a corresponding first unit cell;
a joint opening of a first unit cell pivotally coupled to a joint opening of a second unit cell via a coupling element, the coupling element and joint openings defining a joint,
the joint comprising a backlash region defined by a clearance between the coupling element and the corresponding joint openings, thereby allowing relative motion between the first unit cell and the second unit cell.

2. The reconfigurable lattice structure of claim 1, the body of each of the first unit cells and the second unit cells comprising a hub element and a plurality of arms extending radially from the central axis of the hub element.

3. The reconfigurable lattice structure of claim 2, the joint openings of the first unit cell and the second unit cell disposed at distal ends of the respective arms.

4. The reconfigurable lattice structure of claim 2, the hub element of each first unit cell and each second unit cell comprising four arms.

5. The reconfigurable lattice structure of claim 2, the coupling element disposed within the joint openings of adjacent arms and pivotally coupling a first unit cell to a laterally adjacent second unit cell.

6. The reconfigurable lattice structure of claim 2, the arms of each first unit cell and the arms of each second unit cell uniformly distributed about their respective central axes.

7. The reconfigurable lattice structure of claim 2, each arm of the first unit cells having a first length and each arm of the second unit cells having a second length, the first length equal to the second length.

8. The reconfigurable lattice structure of claim 1, further comprising an actuator operatively coupled to a first unit cell.

9. The reconfigurable lattice structure of claim 1, further comprising a covering layer disposed over the plurality of first unit cells, the plurality of first unit cells disposed between the covering layer and the plurality of second hub elements.

10. The reconfigurable lattice structure of claim 8, the covering layer comprising an elastic material.

11. The reconfigurable lattice structure of claim 1, further comprising a plurality of locking mechanisms restricting reconfiguration in one or more regions of the reconfigurable lattice structure under an applied stress.

12. The reconfigurable lattice structure of claim 1, at least one second unit cell comprising a locking mechanism selectively restricting rotation of the first unit cell to which it is coaxially aligned and coupled.

13. The reconfigurable lattice structure of claim 12, the locking mechanism comprising a latch.

14. The reconfigurable lattice structure of claim 1, the reconfigurable lattice structure transitioning from a planar configuration to a non-planar configuration in response to an applied mechanical force.

15. The reconfigurable lattice structure of claim 1, the reconfigurable lattice structure transitioning from a first non-planar configuration to a second non-planar configuration in response to an applied mechanical force.

16. The reconfigurable lattice structure of claim 1, the reconfigurable lattice structure expanding in a direction orthogonal to an in-plane tensile stress.

17. The reconfigurable lattice structure of claim 1, the reconfigurable lattice structure compliant in a direction perpendicular to the first surface region and the second surface region.

18. The reconfigurable lattice structure of claim 1, the first surface region and the second surface region each defining a surface that is one of an open surface or a closed surface.

19. The reconfigurable lattice structure of claim 1, the pivotally coupled unit cell laterally adjacent to the first unit cell.

20. The reconfigurable lattice structure of claim 1, the coupling element comprising a pin.

21. A method of configuring a reconfigurable lattice structure, comprising:
defining a target geometry, the target geometry corresponding to a final configuration of the reconfigurable lattice structure;
generating a geometric model of the reconfigurable lattice structure, the geometric model corresponding to an initial configuration of the reconfigurable lattice structure;
determining local dilation factors for regions of the reconfigurable lattice structure based on the geometric difference between the geometric model and the target geometry;
determining implementation parameters to match the local dilation factors; and
applying the implementation parameters to the reconfigurable lattice structure,
thereby reconfiguring the reconfigurable lattice structure from the initial configuration to the final configuration.
